(19) United States
(12) Patent Application Publication
(10) Pub. No.: US 2025/0233186 A1
(43) Pub. Date: Jul. 17, 2025

(54) LOAD DETECTION APPARATUS FOR FUEL CELL STACK

(71) Applicant: HONDA MOTOR CO., LTD., Tokyo (JP)

(72) Inventors: Keita IWAYA, Saitama (JP); Tatsuru SHISHIDO, Saitama (JP)

(21) Appl. No.: 19/012,998

(22) Filed: Jan. 8, 2025

(30) Foreign Application Priority Data
Jan. 12, 2024 (JP) 2024-003523

(51) Int. Cl. H01M 8/2404; G01N 3/06; G01N 3/12; H01M 8/242; H01M 8/248

(52) U.S. Cl. CPC H01M 8/2404; G01N 3/066; G01N 3/12; H01M 8/248; G01N 2203/0252; G01N 2203/0676; G01N 2203/0682; H01M 8/242

(57) ABSTRACT

A load detection apparatus capable of appropriately detecting a load applied to the entirety of power generation cells is provided. A load detection apparatus 1 of a fuel cell stack 10 for manufacturing the fuel cell stack 10 includes a press 72 that presses the fuel cell stack 10 in a stacking direction 101, a first load detector 76 that is provided above the fuel cell stack 10, and when the press 72 presses the fuel cell stack 10, detects a load of the fuel cell stack 10, a second load detector 77 that is provided below the fuel cell stack 10, and when the press 72 presses the fuel cell stack 10, detects a load of the fuel cell stack 10.

### CROSS REFERENCE TO RELATED APPLICATIONS

This application claims the benefit of priority to Japanese Patent Application No. 2024-003523 filed on Jan. 12, 2024. The entire contents of this application are hereby incorporated herein by reference.

### BACKGROUND OF THE INVENTION

### Field of the Invention

The present invention relates to a load detection apparatus for a fuel cell stack including a stacked body in which a plurality of power generation cells are stacked.

### Related Art

The polymer electrolyte fuel cell includes an electrolyte membrane/electrode assembly (MEA). Electrodes are respectively provided on both sides of the solid polymer electrolyte membrane of the electrolyte membrane/electrode assembly. A seal member is provided on the outer periphery of the electrolyte membrane/electrode assembly. The seal member is a member for preventing leakage of fuel gas, refrigerant, and the like. The electrolyte membrane/electrode assembly is sandwiched between separators to provide a power generation cell. The number of power generation cells required to obtain a desired voltage is stacked to provide a stacked body. The stacked body is used in the form of a fuel cell stack to which an end plate or the like is attached.
Patent Document 1: Japanese Unexamined Patent Application, Publication No. 2012-185920

### SUMMARY OF THE INVENTION

Thus far, a technique has not been proposed which appropriately detects a load applied to the entire power generation cell in a process of forming a stacked body by stacking power generation cells. Therefore, there is a problem in that it is difficult to find an appropriate load condition.

An object of the present invention is to provide a load detection apparatus capable of appropriately detecting a load applied to the entirety of power generation cells.

A load detection apparatus of a fuel cell stack for manufacturing the fuel cell stack according to the present invention includes: a press that presses the fuel cell stack in a stacking direction; a first load detector that is provided above the fuel cell stack, and when the press presses the fuel cell stack, detects a load of the fuel cell stack; a second load detector that is provided below the fuel cell stack, and when the press presses the fuel cell stack, detects a load of the fuel cell stack.

According to the load detection apparatus described above, it is possible to provide a load detection apparatus capable of appropriately detecting a load applied to the entirety of the power generation cells.

The first load detector and the second load detector may each include two or more load cells.

According to the load detection apparatus described above, it is possible to detect the loads applied to different portions of the power generation cell.

Each of the first load detector and the second load detector may include a movable plate having one surface which is in contact with at least a corresponding one of the two or more load cells and one other surface which is in contact with the fuel cell stack, the movable plate may be divided into two or more parts in a plan view,
in a case in which the two or more parts are set as partial plates, a corresponding one of the partial plates included in the first load detector and a corresponding one of the partial plates included in the second load detector may be placed at a same or substantially same position in a plan view, and the corresponding one of the two or more load cells included in the first load detector and the corresponding one of the two or more load cells included in the second load detector may be attached at a same or substantially same position in a plan view.

According to the load detection apparatus described above, it is possible to accurately detect the loads applied to different portions of the power generation cell.

The partial plates may each include a first partial plate located in a middle of the movable plate in a plan view and a second partial plate that covers an outer periphery of the first partial plate in a plan view.

According to the load detection apparatus described above, it is possible to accurately detect the loads applied to the different functional portions of the power generation cell.

The fuel cell stack may include a power generation cell, the power generation cell may include an electrolyte membrane/electrode assembly and a resin frame member, the first partial plate may be located at a portion in which the electrolyte membrane/electrode assembly is stacked in a plan view, and the second partial plate may be located at a portion in which the resin frame member is stacked in a plan view.

According to the load detection apparatus described above, it is possible to accurately detect the loads applied to the portion where the electrodes are stacked and the portion where the frames are stacked in the power generation cell.

According to the present invention, it is possible to provide a load detection apparatus capable of appropriately detecting a load applied to the entirety of power generation cells.

### BRIEF DESCRIPTION OF THE DRAWINGS

FIG. 1 is a perspective view of a fuel cell stack according to an embodiment of the present invention;

FIG. 2 is a view showing a load detection apparatus of the fuel cell stack of the present embodiment;

FIG. 3A shows a first partial plate;

FIG. 3B shows a second partial plate;

FIG. 4A is a graph showing a detection result of a load at the first partial plate; and

FIG. 4B is a graph showing a detection result of a load at the second partial plate.

### DETAILED DESCRIPTION OF THE INVENTION

### (Fuel Cell Stack)

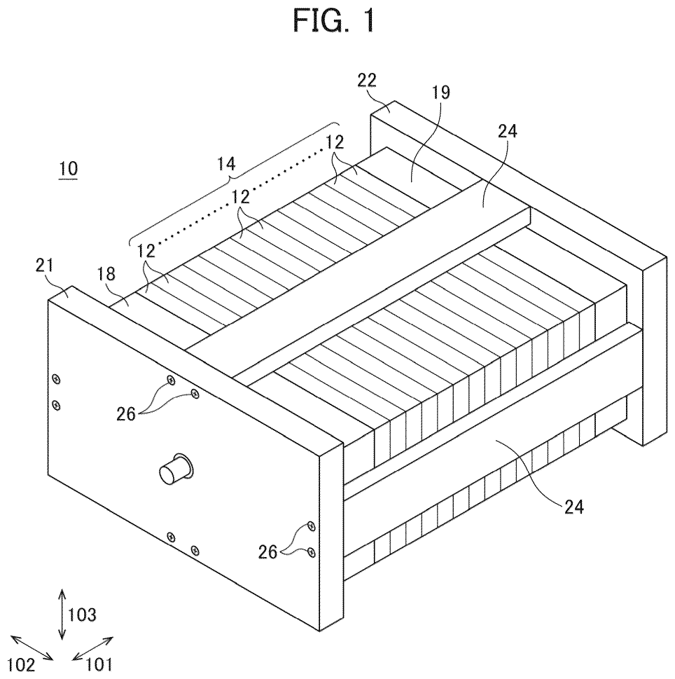

A load detection apparatus 1 for manufacturing a fuel cell stack 10 according to an embodiment of the present invention will be described. Before describing the load detection apparatus 1, the fuel cell stack 10 will be described. FIG. 1 is a perspective view of the fuel cell stack 10 according to the present embodiment. The fuel cell stack 10 includes a stacked body 14. The stacked body 14 includes a plurality of stacked power generation cells 12. FIG. 1 shows a first direction 101, a second direction 102, and a third direction 103. The first direction 101, the second direction 102, and the third direction 103 are orthogonal or substantially orthogonal to one another. The first direction 101 is a direction in which the power generation cells 12 are stacked. The first direction 101 is referred to as a stacking direction 101. Further, a view in the first direction 101 is referred to as a plan view.

At one end of the stacked body 14 in the stacking direction 101, a first insulator 18 and a first end plate 21 are provided in this order toward the outside of the stacked body 14. At the other end of the stacked body 14 in the stacking direction 101, a second insulator 19 and a second end plate 22 are provided in this order toward the outside of the stacked body 14. The material of the insulator is, for example, an insulating material such as polycarbonate and phenol resin. A spacer may be provided between the stacked body 14 and the end plate.

As shown in FIG. 1, each of the end plates has a rectangular shape. A coupling bar 24 is provided between opposing sides of the first end plate 21 and the second end plate 22. Both ends of the coupling bar 24 are fixed to the respective end plates by bolts 26. The distance between the first end plate 21 and the second end plate 22 is fixed by fixing both end plates via the coupling bar 24. A fastening load in the stacking direction 101 is applied to each power generation cell 12.

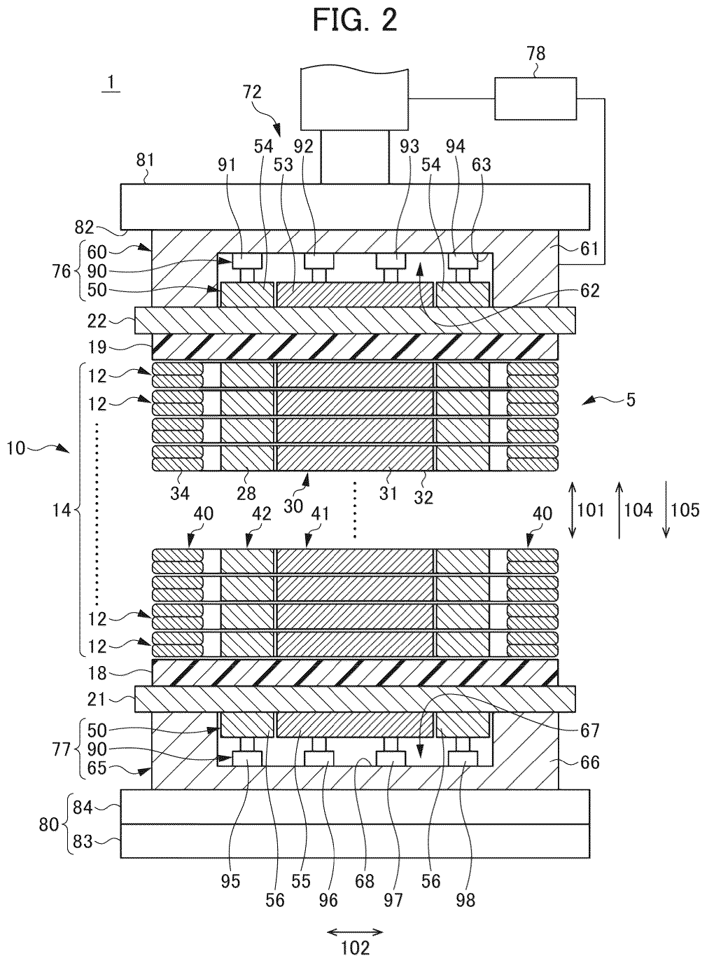

The configurations of the power generation cells 12 and the stacked body 14 will be described with reference to FIG. 2. FIG. 2 is a view showing the load detection apparatus 1 of the fuel cell stack 10 of the present embodiment. FIG. 2 shows a state in which the fuel cell stack 10 including the stacked body 14 and the other components is installed in the load detection apparatus 1.

### (Power Generation Cell)

As shown in FIG. 2, each of the power generation cells 12 has a structure in which an electrolyte membrane/electrode assembly 30 is sandwiched between conductive separators 32. A resin frame member 28 is provided around the electrolyte membrane/electrode assembly 30.

The electrolyte membrane/electrode assembly 30 includes a solid polymer electrolyte membrane 31. The resin frame member 28 surrounds the outer periphery of the solid polymer electrolyte membrane 31. The resin frame member 28 has a frame shape in a plan view.

The separator 32 is made of a conductive material such as metal and carbon. A seal member 34 is provided to surround the outer peripheral end portion of the separator 32. The seal member 34 is made of an elastic material such as rubber.

### (Stacked Body)

A stack of a plurality of power generation cells 12 is referred to as a stacked body 14.

### (Seal Stack Portion)

Seal stack portions 40 are provided at the outer edge of the stacked body 14. Each of the seal stack portions 40 is a portion in which the seal members 34 are stacked.

### (Electrode Stack Portion)

An electrode stack portion 41 is provided inside the seal stack portions 40 in the stacked body 14. The electrode stack portion 41 is a portion in which the electrolyte membrane/electrode assemblies 30 are stacked.

### (Frame Stack Portion)

Frame stack portions 42 are provided between the seal stack portions 40 and the electrode stack portion 41. Each of the frame stack portions 42 is a portion in which the resin frame members 28 are stacked.

### (Load Detection Apparatus for Fuel Cell Stack)

The load detection apparatus 1 of the fuel cell stack 10 will be described with reference to FIG. 2. The load detection apparatus 1 mainly includes a pressing unit 72, a control unit 78, a pressing plate 81, a first load detection unit 76, a second load detection unit 77, and a holding table 80. As shown in FIG. 2, in the stacking direction 101, a direction indicated by an arrow 104 is referred to as an upward direction 104. In the stacking direction 101, a direction indicated by an arrow 105 is referred to as a downward direction 105. The holding table 80 is provided on the lower side in the downward direction 105 in the load detection apparatus 1. The pressing plate 81 is provided on the upper side in the upward direction 104 in the load detection apparatus 1. An object which is provided between the holding table 80 and the pressing plate 81 of the load detection apparatus 1 and is pressed is referred to as a pressing target 5. In the example shown in FIG. 2, the pressing target 5 is the fuel cell stack 10. The pressing target 5 is not limited to the fuel cell stack 10. The pressing target 5 may be, for example, the stacked body 14 or the like.

### (Pressing Unit)

The pressing unit 72 presses the pressing target 5 in the downward direction 105 by bringing the pressing plate 81 close to the holding table 80. The downward direction 105 is referred to as a pressing direction. The pressing unit 72 can apply a load to the pressing target 5. The pressing unit 72 may be, for example, a press mechanism such as a servo press.

### (Pressing Plate)

The pressing plate 81 is a portion that applies a load to the pressing target 5 by being pressed by the pressing unit 72. The holding table 80 is a portion on which the pressing target 5 is placed. The holding table 80 includes a base 83 and a placement jig 84. The placement jig 84 is provided between the base 83 and the pressing target 5. The placement jig 84 has, for example, a shape capable of stably arranging the first end plate 21 in a predetermined direction.

The load detection apparatus 1 of the present embodiment includes two load detection units. One load detection unit is referred to as a first load detection unit 76, and the other load detection unit is referred to as a second load detection unit 77. The first load detection unit 76 is provided on the upper side in the upward direction 104 of the pressing target 5 in the stacking direction 101. The second load detection unit 77 is provided on the lower side in the downward direction 105 of the pressing target 5 in the stacking direction 101.

### (First Load Detection Unit)

The first load detection unit 76 includes a first fixed member 60, a movable plate 50, and a load cell 90.

### (First Fixed Member)

The first fixed member 60 is fixed to a lower surface 82 of the pressing plate 81. The lower surface 82 of the pressing plate 81 is a surface of the pressing plate 81 facing the pressing target 5. The first fixed member 60 includes an outer frame portion 61 and a recessed portion 62. The outer frame portion 61 is a portion extending in the downward direction 105 from the lower surface 82 of the pressing plate 81 in the outer peripheral portion of the first fixed member 60. When the pressing target 5 includes the stacked body 14, the outer frame portion 61 is provided at a position corresponding to the seal stack portion 40 of the stacked body 14. The recessed portion 62 is a portion whose outer periphery is surrounded by the outer frame portion 61.

### (Movable Plate)

Each of the movable plates 50 is a plate-shaped member movable in the stacking direction 101. One surface of the movable plate 50 is in contact with the pressing target 5. The other surface of the movable plate 50 is in contact with a load cell 90.

### (Load Cell)

The load cell 90 measures a load by being pushed into the movable plate 50. The load cell 90 is provided between the first fixed member 60 and the movable plate 50 in the stacking direction 101. The load cell 90 is provided in the recessed portion 62 of the first fixed member 60. The load cell 90 is fixed to the lower surface 63 of the first fixed member 60 in the downward direction 105.

The outer frame portion 61 of the first fixed member 60 covers the outer side of the movable plate 50. The outer frame portion 61 of the first fixed member 60 regulates the movement of the movable plate 50 in the stacking direction 101.

### (Second Load Detection Unit)

In the load detection apparatus 1 of the present embodiment, in addition to the first load detection unit 76, the second load detection unit 77 is provided in the downward direction 105 of the pressing target 5. The second load detection unit 77 has the same or substantially the same configuration as the first load detection unit 76. However, the second load detection unit 77 is provided in a direction in which the first load detection unit 76 is vertically inverted.

Specifically, as shown in FIG. 2, the second fixed member 65 is provided on the holding table 80. The outer frame portion 66 of the second fixed member 65 has a protruding shape in the upward direction 104. The recessed portion 67 of the second fixed member 65 has a recessed shape opened in the upward direction 104. The load cell 90 is provided in the recessed portion 67. The lower surface of the movable plate 50 included in the second load detection unit 77 is in contact with the load cell 90.

### (Control Unit)

The control unit 78 is a part that controls the operation of the load detection apparatus 1. The control unit 78 controls the pressing unit 72 to adjust the force pressing the pressing plate 81, the speed at which the pressing plate 81 is moved, and the like. The load detected by the load cell 90 is inputted to the control unit 78.

In the load detection apparatus 1 of the present embodiment, the load detection units are provided in the upward direction 104 and the downward direction 105 of the pressing target 5. Therefore, it is possible to more finely detect the load applied to the pressing target 5 than the load detection apparatus in which the load detection unit is provided only in the upward direction 104, for example.

Each of the first load detection unit 76 and the second load detection unit 77 includes a plurality of load cells 90. Therefore, it is possible to more finely detect the load applied to the pressing target 5.

### (Partial Plate)

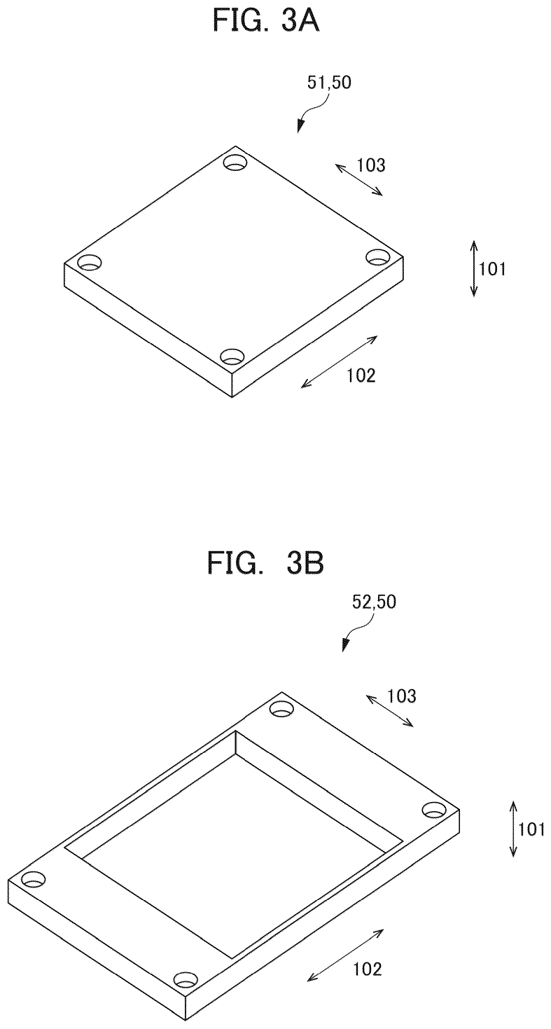

In the load detection apparatus 1 of the present embodiment, the movable plate 50 is divided into two parts. As shown in FIG. 2, the movable plate 50 included in the first load detection unit 76 is divided into a first upper partial plate 53 and a second upper partial plate 54. The movable plate 50 included in the second load detection unit 77 is divided into a first lower partial plate 55 and a second lower partial plate 56. This will be described with reference to FIGS. 3A and 3B.

FIG. 3A shows a first partial plate 51. FIG. 3B shows a second partial plate 52. The movable plate 50 is divided into a first partial plate 51 and a second partial plate 52. That is, the movable plate 50 is formed by combining the first partial plate 51 and the second partial plate 52.

The first partial plate included in the first load detection unit 76 is referred to as the first upper partial plate 53, and the first partial plate included in the second load detection unit 77 is referred to as the first lower partial plate 55. The first upper partial plate 53 and the first lower partial plate 55 have the same or substantially the same shape at least in a plan view.

Similarly, the second partial plate included in the first load detection unit 76 is referred to as the second upper partial plate 54, and the second partial plate included in the second load detection unit 77 is referred to as the second lower partial plate 56. The second upper partial plate 54 and the second lower partial plate 56 have the same or substantially the same shape at least in a plan view.

### (First Partial Plate)

As shown in FIG. 3A, the first partial plate 51 is a plate located in the middle of the movable plate 50 in a plan view. The first partial plate 51 has a quadrangular shape in a plan view.

### (Second Partial Plate)

As shown in FIG. 3B, the second partial plate 52 is a plate located on the outer periphery of the movable plate 50 in a plan view. The second partial plate 52 has a rectangular frame shape in a plan view. The second partial plate 52 has a shape that covers the outer periphery of the first partial plate 51 in a plan view.

The entire movable plate 50 is formed by placing the first partial plate 51 in the frame of the second partial plate 52.

The first upper partial plate 53 and the first lower partial plate 55 are provided to overlap each other in a plan view. Similarly, the second upper partial plate 54 and the second lower partial plate 56 are provided to overlap each other in a plan view.

That is, the first upper partial plate 53 and the first lower partial plate 55 are provided at the same or substantially the same position in a plan view. Further, the second upper partial plate 54 and the second lower partial plate 56 are provided at the same or substantially the same position in a plan view.

The number of partial plates when dividing the movable plate is not limited to two. The movable plate may be divided into three or more partial plates. Further, the shapes of the partial plates in a plan view are not limited to the examples shown in FIGS. 3A and 3B.

### (Load Cell)

The load cell 90 will be described. As described above, two or more load cells 90 are included in each of the first load detection unit 76 and the second load detection unit 77. The first partial plate 51 and the second partial plate 52 are in contact with one or more load cells 90.

In the example shown in FIG. 2, at the position in the third direction 103 shown in FIG. 2 (at the position of the cross section shown in FIG. 2), each of the first load detection unit 76 and the second load detection unit 77 includes four load cells 90. The load cells 90 included in the first load detection unit 76 are referred to as a first load cell 91, a second load cell 92, a third load cell 93, and a fourth load cell 94. The load cells 90 are arranged in order in the second direction 102.

Similarly, the load cells 90 included in the second load detection unit 77 are referred to as a fifth load cell 95, a sixth load cell 96, a seventh load cell 97, and an eighth load cell 98. The load cells 90 are arranged in order in the second direction 102.

In addition, FIG. 2 illustrates the load cells 90 aligned in the second direction 102 at a position in the third direction 103. The plurality of load cells 90 may be placed in the third direction 103. That is, the plurality of load cells 90 may be provided in two dimensions on the fixed member.

### (Partial Plate and Load Cell)

In the example shown in FIG. 2, the second load cell 92 and the third load cell 93 are in contact with the first upper partial plate 53. The first load cell 91 and the fourth load cell 94 are in contact with the second upper partial plate 54.

Similarly, the sixth load cell 96 and the seventh load cell 97 are in contact with the first lower partial plate 55. Further, the fifth load cell 95 and the eighth load cell 98 are in contact with the second lower partial plate 56.

With such a configuration, it is possible to separately detect the loads applied to the first upper partial plate 53, the second upper partial plate 54, the first lower partial plate 55, and the second lower partial plate 56.

In addition, the load applied to the first upper partial plate 53 may be the sum of the load of the second load cell 92 and the load of the third load cell 93. In addition, the load applied to the second upper partial plate 54 may be the sum of the load of the first load cell 91 and the load of the fourth load cell 94. The same can also apply to the first lower partial plate 55 and the second lower partial plate 56.

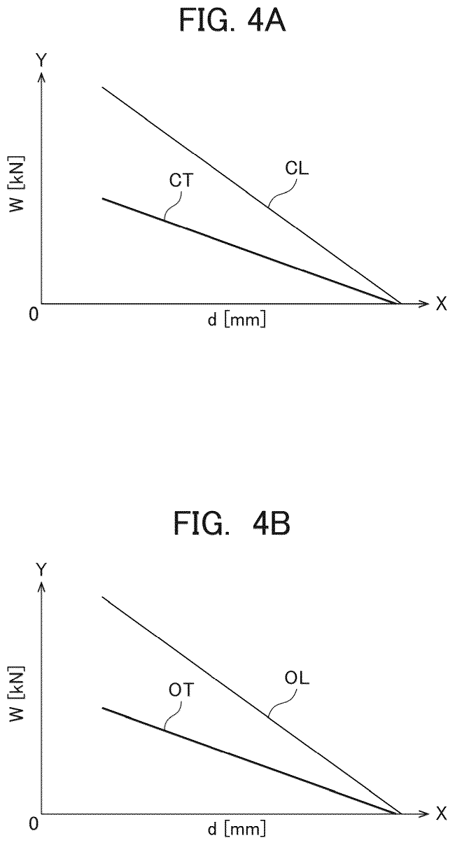

An example of load detection using the load detection apparatus 1 of the present embodiment will be described. FIG. 4A is a graph showing the detection result of the load in the first partial plate 51. FIG. 4B is a graph showing the detection result of the load in the second partial plate 52. The X-axis in FIGS. 4A and 4B represents the thickness d (mm) of the fuel cell stack 10 as the pressing target 5. The Y-axis in FIGS. 4A and 4B represents the load W (kN) detected by the load cell 90.

The line CT in FIG. 4A represents the load of the first upper partial plate 53, and the line CL in FIG. 4A represents the load of the first lower partial plate 55. The line OT in FIG. 4B represents the load of the second upper partial plate 54, and the line OL in FIG. 4B represents the load of the second lower partial plate 56.

In the example shown in FIGS. 4A and 4B, the lower side (CL) is higher than the upper side (CT) in the load of the middle portion of the pressing target 5 detected by the first partial plate 51 in a plan view, as shown in FIG. 4A. On the other hand, as shown in FIG. 4B, the upper side (OT) is higher than the lower side (OL) in the load of the peripheral portion of the pressing target 5 detected by the second partial plate 52 in a plan view.

From these results, it is inferred that the pressing target 5 has a shape in which the peripheral portion is raised and the middle portion is recessed.

Further, in a case where the magnitude relationship between the loads on the upper side and the lower side is opposite to the example shown in FIGS. 4A and 4B, it is presumed that the pressing target 5 has a shape in which the middle portion is raised and the peripheral portion is lowered.

In addition, when the magnitude relationship between the loads on the upper side and the lower side is not different, it is presumed that the pressing target 5 has a flat or substantially flat shape.

In this way, the movable plate and the load cell are provided on the upper side and the lower side, the movable plate is divided into the partial plates, and the load of each partial plate can be measured, whereby it is possible to grasp the shape of the pressing target 5 and the shared load of each portion of the pressing target 5. This makes it possible to predict the behavior of the pressing target 5 at the time of pressing.

In a case in which the pressing target 5 is the fuel cell stack 10, it is possible to predict the behavior of the entire fuel cell stack 10 or the entire stacked body 14 included in the fuel cell stack 10 at the time of pressing. In addition, in a case in which the pressing target 5 is the stacked body 14, it is possible to predict the behavior of the entire stacked body 14 at the time of pressing.

### (Positional Relationship Between Electrode Stack Portion and Frame Stack Portion)

In the load detection apparatus 1 of the present embodiment, the first upper partial plate 53 and the first lower partial plate 55 are located at the electrode stack portion 41 in a plan view. On the other hand, the second upper partial plate 54 and the second lower partial plate 56 are located at the frame stack portion 42 in a plan view.

By arranging the first partial plate 51 and the second partial plate 52 at the above-described positions, it is possible to separately detect the load applied to the electrode stack portion 41 which is a portion where the electrolyte membrane/electrode assemblies 30 are stacked in the stacked body 14, and the load applied to the frame stack portion 42 which is a portion where the resin frame members 28 are stacked in the stacked body 14. This makes it possible to detect the load applied to each functional portion of the power generation cell more accurately.

Embodiments of the present invention have been described above. The present invention is not limited to the embodiments described above, and various modifications, variations, and combinations are possible.

### EXPLANATION OF REFERENCE NUMERALS

1 load detection unit
5 pressing target
10 fuel cell stack
12 power generation cell
14 stacked body
50 movable plate
51 first partial plate
52 second partial plate
53 first upper partial plate
54 second upper partial plate
55 first lower partial plate
56 second lower partial plate
60 first fixed member
65 second fixed member
72 pressing unit
76 first load detection unit
77 second load detection unit
90 load cell

What is claimed is:

1. A load detection apparatus of a fuel cell stack for manufacturing the fuel cell stack, the load detection apparatus comprising:
a press that presses the fuel cell stack in a stacking direction;
a first load detector that is provided above the fuel cell stack, and when the press presses the fuel cell stack, detects a load of the fuel cell stack; and
a second load detector that is provided below the fuel cell stack, and when the press presses the fuel cell stack, detects a load of the fuel cell stack.

2. The load detection apparatus of a fuel cell stack according to claim 1, wherein the first load detector and the second load detector each include two or more load cells.

3. The load detection apparatus of a fuel cell stack according to claim 2, wherein
each of the first load detector and the second load detector includes a movable plate having one surface which is in contact with at least a corresponding one of the two or more load cells and one other surface which is in contact with the fuel cell stack,
the movable plate is divided into two or more parts in a plan view,
in a case in which the two or more parts are set as partial plates, a corresponding one of the partial plates included in the first load detector and a corresponding one of the partial plates included in the second load detector are placed at a same or substantially same position in a plan view, and
the corresponding one of the two or more load cells included in the first load detector and the corresponding one of the two or more load cells included in the second load detector are attached at a same or substantially same position in a plan view.

4. The load detection apparatus of a fuel cell stack according to claim 3, wherein the partial plates each include a first partial plate located in a middle of the movable plate in a plan view and a second partial plate that covers an outer periphery of the first partial plate in a plan view.

5. The load detection apparatus of a fuel cell stack according to claim 4, wherein
the fuel cell stack includes a power generation cell,
the power generation cell includes an electrolyte membrane/electrode assembly and a resin frame member,
the first partial plate is located at a portion in which the electrolyte membrane/electrode assembly is stacked in a plan view, and
the second partial plate is located at a portion in which the resin frame member is stacked in a plan view.
